(19) United States
(12) Patent Application Publication
(10) Pub. No.: US 2009/0187327 A1
(43) Pub. Date: Jul. 23, 2009

(54) Liquid Pump Control System

(75) Inventors: Eric Grant, Ypsilanti, MI (US); Ryan McCleary, White Lake, MI (US); Ron Behar, Williamsport, PA (US); David Hill, Commerce Township, MI (US); Scott McCleary, White Lake, MI (US); Saurin Mehta, Troy, MI (US)

Correspondence Address: Solvay;c/o B. Ortego - IAM-NAFTA, 3333 Richmond Avenue, Houston, TX, 77098-3099, US

(73) Assignee: Inergy Automotive Systems Research, Brussels (BE)

(21) Appl. No.: 12/064,333

(22) PCT Filed: Aug. 21, 2006
(86) PCT No.: PCT/EP06/65491

§ 371 Date: Jun. 23, 2008

Related U.S. Application Data
(60) Provisional application No. 60/751,343, filed on Dec. 16, 2005.

(30) Foreign Application Priority Data
Aug. 22, 2005 (EP) 05107665.1

(51) Int. Cl. F02D 41/00; F02M 59/36

(52) U.S. Cl. 701/103; 123/458

(57) ABSTRACT

Fuel or additive pump control system comprising a fuel or additive system control unit (FSCU(6)), which communicates with an engine control unit (EDU(I)) through communication means (13). The FSCU comprises means using data from the ECU for calculating a desired fuel or additive pressure, means (10) for comparing the desired fuel or additive pressure (9) with an actual fuel or additive pressure and means for generating a fuel or additive pump control signal.

This application claims priority to U.S. provisional application 60/751343 filed on Dec. 16, 2005 and incorporated herein by reference.

It relates to a liquid pump control system.

Current fuel systems operate a fuel pump at full output while the vehicle is running, utilizing a mechanical pressure regulator to provide a constant fuel pressure to the engine. Operating the fuel pump at full power is wasteful by increasing draw on the vehicle's electrical system, thereby causing lower fuel economy. In addition, since the current delivery fuel pressure is constant, larger injectors are required for the engine to provide top performance in all engine conditions. The mechanical pressure regulator currently used also adds additional cost to the system.

A “variable pressure deadheaded fuel rail fuel pump control system” is known from U.S. Pat. No. 5,355,859. This system specifies a variable pressure system through varying power to the fuel pump. The amount of power supplied is governed by an ECU (Engine Control Unit), which takes throttle position, manifold absolute pressure, engine speed, and fuel rail pressure to determine and obtain the desired fuel rail pressure.

This central control increases the number of wires needed, and overloads the processing capabilities of the ECU, presenting less reliability.

The present invention aims at separating out the control of the fuel system into a completely different control unit, i.e. the FSCU (Fuel System Control Unit).

Other systems with a finite variable (e.g. 2 or 3 speeds) speed control system for the fuel pump are also known. They aim at reducing power draw of the fuel pump and eliminating the need for a pressure regulator but they don't govern continuously the power output of the pump with a dedicated control unit.

Applicant's invention deals with a continuously variable control of the pump output and is able to target any fuel pressure that the fuel pump is capable of producing.

Reliability is increased by segmenting control of the fuel system away from the ECU, reducing load on the ECU.

Cost is reduced by removing need for mechanical regulator and by combining rail pressure targeting calculations and pump control into same unit that will carry out on-board diagnostics (OBD) and venting functionalities.

Ease of integration is improved with an almost drop-in type of system.

Modularity and flexibility of this system, which is separated from the vehicle's ECU and the specific load sensors available. This allows for the invention's system to be integrated nearly turnkey into many different vehicles across many platforms and OEM's.

A similar problem may be encountered when dosing an additive intended to be injected in the exhaust gases of an engine for the SCR (Selective Catalytic Reduction) of the NOx contained therein), since its metering into the exhaust gases usually uses a pump and a controller as well. Such an additive may be an ammoniac precursor like urea for instance (usually in aqueous solution). Uncoupling this control from the ECU also would add flexibility and reliability to the vehicle functions. And allowing to adapt the pump speed at the required pressure could also increase the economy of the system.

Hence, the present invention relates to a fuel or additive pump control system integrated to a fuel or additive system control unit (FSCU), and communicating with an engine control unit (ECU) through communication means; the FSCU comprising means using data from the ECU for calculating a desired fuel or additive pressure, means for comparing the desired fuel or additive pressure with an actual fuel or additive pressure and means for generating a fuel or additive pump control signal.

According to the invention the fuel or additive pump control system is integrated to a fuel or additive system control unit (FSCU). The FSCU can manage the operating conditions and functioning parameters of a fuel or an additive system.

The FSCU generally
has means for controlling functions of the fuel or additive system,
is connected with at least one fuel or additive system component to send signals or receive signals from said at least component,
is connected with at least one sensor that sends signals to the FSCU and/or the ECU,
is adapted to electronically and bi-directionally communicate with the ECU.

The FSCU is a standalone controller, different from the ECU and which has taken over the control of the fuel or additive system from the ECU, i.e. the ECU doesn't directly control the fuel system any longer. The FSCU communicates with the ECU also for indication of any fuel system failure to the ECU.

In general, a fuel system integrates a fuel tank and among other components, a fuel pump (which draws fuel from the fuel tank and discharges fuel from the fuel tank through an opening in the fuel tank wall), a fuel vapour canister (through which any air or fuel vapour received into or discharged out of the fuel tank travels), one or several vapour or roll-over-valves (communicating with the fuel vapour canister) or any other fuel system component. An additive system generally also comprises a pump, and it may comprise a canister and at least one venting valve as well.

The FSCU controls the operation of all these components during normal and transient operating conditions of the engine, receives data on the operating parameters and sends information to make the component function. In general this control was previously made by the ECU or by component-dedicated electronic controllers (for instance, specific controllers exist for fuel pump management). The burden of controlling the fuel or additive system is switched to the FSCU. It is to be understood that according to the invention, there may be only one FSCU controlling both the fuel and the additive injection. Alternatively, there is a specific FSCU for fuel and a separate controller for the additive (or ASCU). And finally, the invention also relates to only one of the fuel system and additive system being equipped with a controller according to the invention. To keep it simple, the rest of the specification will only relate to the fuel aspect, but it should be understood as covering also (being applicable as well to) additive systems.

Preferably the FSCU is electronically connected to sensors integrated in the fuel system. Among fuel system sensors there are generally a fuel level sensor, a temperature sensor, a pressure sensor, a hydrocarbon vapour sensor, one or several On-Board-Diagnostic (OBD) sensors. Other types of sensors can be part of this list. They are connected to the FSCU by appropriate electric wires through which sensors transmit data to the FSCU.

The FSCU may receive information from and send information to a plurality of vehicle control systems including the ECU through a limited number of wires. The information exchanged between the FSCU and the ECU includes for instance the quantity of fuel in the fuel tank (returned from the fuel level sensor), the injector pulse width (indicating how much fuel has to be injected), a signal indicating if purge conditions for the canister are met, . . .

The FSCU may also receive signals from OBD sensors used to determine if there are any fuel system component failures or failures in the evaporative emission control system which may be indicated, for example, by liquid fuel leakage or pressure losses in the system. These failure conditions may result in the discharge of liquid fuel or hydrocarbon vapours from the fuel system. OBD sensors may also indicate vacuum conditions in the fuel tank.

According to the invention, the FSCU integrates a fuel pump controller.

In a particular embodiment of the invention the FSCU comprises a controller with software based proportional-derivative-integral (PID) modified algorithm for computing a difference between the desired fuel pressure and the actual fuel pressure, using said difference with information from previous computations to calculate PID parameters in order to change the fuel pump control signal. This signal controls the power provided to the fuel pump. The PID algorithm takes the proportion of an error, the integral of the error (total error over time), and the derivative of error (rate of error change) and combines them to modify the output to eliminate the error.

Data used for calculating the desired fuel pressure generally comprises throttle position, engine load, engine coolant temperature, air charge temperature, and potentially any other signal available on a vehicle communication bus. Input of throttle position and engine load may be abstracted regardless of sensors used and sent over a network bus of an OEM's (original equipment manufacturer) choice. Targeted fuel pressure and current fuel pressure will then be sent back to the ECU so that any adjustments in engine operation can then be made.

In particular the control system comprises power driver means responsive to said pump control signal for generating a power electrical signal to a fuel pump.

In an embodiment of the present invention the FSCU controls the application of electrical power to the fuel pump thanks to a pulse-width-modulated (PWM) variable duty cycle signal or variable voltage signal that is generated according to any request from the ECU for fuel delivery to the fuel injectors. Accordingly, there is at least one analog pressure sensor in communication with the fuel pump outlet to provide the FSCU with an indication of the fuel pump output pressure.

The FSCU may also comprise other controlling functionalities beside that of controlling the fuel pump.

The controlling functionalities may comprise on-board diagnostics and venting.

The FSCU may also control the vapour management in the fuel system. As already mentioned, the purging of the fuel vapour canister is under the control of the FSCU. This control can be dealt with through a purge control valve (e.g. three-way switching valve embodied in a solenoid actuator) that allows communication between the canister and the engine air intake system. The actuator opens the purge control valve under a predetermined operating condition of the engine to connect the canister and the air intake system, thereby generating a purge gas flow through the canister.

According to another particular embodiment of the invention, the FSCU also comprises relays (e.g. solenoid relays) in particular for providing indication of a refueling event of the fuel tank, to control vapour venting of the fuel system, to control an additive dosing system and to control a capless fill head.

The FSCU advantageously also communicates with the ECU preferably via the vehicle CAN bus since this communication medium is less sensitive to electronic bugs. Through this multiplex bus, the ECU sends messages to the FSCU to enable the fuel pump, to control the output pressure of the fuel pump if a variable speed fuel pump is provided, to disable the fuel pump in the event of a vehicle accident, to control the purging of the vapour canister, to indicate the ambient temperature, to indicate the engine temperature and to request information from one or more sensors such as OBD sensors.

It is preferred that the FSCU is a low power microprocessor, e.g. with a voltage of 5V. This type of microprocessor may have advantageously the following allocations: a ROM of 128 kilobytes, a volatile memory of 4 kilobytes and a non-volatile memory of 2 kilobytes.

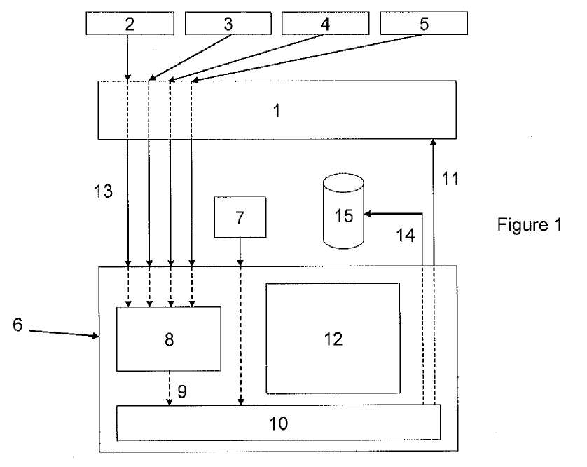

FIGS. 1 illustrates the subject matter of the invention but is not to be construed as limiting its scope.

The ECU (Engine Control Unit) (1) or other similar device collects information related to vehicle throttle position (2), load (via MAP (Mass Air Pressure), MAF (Mass Air Flow), RPM (Revolutions Per Minute), or other load indicator) (3), ECT (Engine Coolant Temperature) (4), and ACT (Air Charge Temperature) (5). The ECU then communicates this information to the FSCU (Fuel System Control Unit) via hard wires or a multiplex communication bus (CAN, LIN, . . . ) (13). The FSCU receives this information, along with fuel pressure (7). Fuel pressure may also be optionally measured by the ECU and communicated with other mentioned signals depending on OEM requirements. The FSCU then calculates desired fuel pressure based upon the load and throttle inputs (8). This desired fuel pressure may then be altered based upon the rate of change of the inputs, and based upon the relation between the ACT and ECT within a finite time interval of vehicle start (indicated by load). The finalized desired fuel pressure (9) is then passed to a PID (Proportional, Integral, and Derivative) modified algorithm (10). The PID algorithm finds the difference between the desired fuel pressure and the actual fuel pressure, which is the amount of error. It then uses this error along with information from previous loop iterations to re-calculate the PID functions in order to modify the fuel pump output (14) in an effort to reduce the error by changing the speed of the fuel pump (15). The fuel pump output is varied utilizing a PWM variable duty cycle signal or another electrical power control method. The resulting fuel pressure is then sent back to the ECU as feedback (11). In between iterations of this process, the FSCU also controls other functionality, including OBD and venting (12).

1. A fuel or additive pump control system integrated to a fuel or additive system control unit (FSCU) (6), and communicating with an engine control unit (ECU) (1) through communication means (13); the FSCU (6) comprising means (8) using data from the ECU for calculating a desired fuel or additive pressure, means (IO) for comparing the desired fuel or additive pressure (9) with an actual fuel or additive pressure (7) and means for generating a fuel or additive pump control signal.

2. The control system according to claim 1, wherein the FSCU (6) comprises a controller (10) with software based proportional-derivative-integral (PID) modified algorithm for computing a difference between the desired fuel or additive pressure (9) and the actual fuel or additive pressure (7), using said difference with information from previous computations to calculate PID parameters in order to change the fuel or additive pump control signal.

3. The control system according to claim 1, wherein data used for calculating the desired fuel or additive pressure (9) comprises at least one of throttle position (2), engine load (3), engine coolant temperature (4), air charge temperature (5), and any other signal available on a vehicle communication bus.

4. The control system according to claim 1, comprising power driver means responsive to said pump control signal for generating a power electrical signal to a fuel or additive pump (15).

5. The control system according to claim 4, wherein said power electrical signal is varied utilizing a pulse-width modulation (PWM) variable duty cycle signal or variable voltage signal.

6. The control system according to claim 1, wherein the FSCU (6) comprises other controlling functionalities (12) beside that of the fuel or additive pump controlling.

7. The control system according to claim 6, where wherein said controlling functionalities (12) comprise on-board diagnostics (OBD) and venting.

8. The control system according to claim 6, wherein the purging of a fuel or additive vapour canister is tinder the control of the FSCU (6).

9. The control system according to claim 1, wherein the FSCU (6) also comprises relays for providing indication of a refueling event of a fuel tank, to control vapour venting of a fuel system, to control an additive dosing system or to control a capless fill head.

10. The control system according to claim 1, wherein the FSCU (6) communicates with the ECU (1) via a CAN bus.
